(19) United States
(12) Patent Application Publication
(10) Pub. No.: US 2014/0065433 A1
(43) Pub. Date: Mar. 6, 2014

(54) COATINGS FOR DISSIPATING VIBRATION-INDUCED STRESSES IN COMPONENTS AND COMPONENTS PROVIDED THEREWITH

(71) Applicants: Yuk-Chiu Lau, Ballston Lake, NY (US); John McConnell Delvaux, Fountain Inn, SC (US)

(72) Inventors: Yuk-Chiu Lau, Ballston Lake, NY (US); John McConnell Delvaux, Fountain Inn, SC (US)

(73) Assignee: GENERAL ELECTRIC COMPANY, Schenectady, NY (US)

(21) Appl. No.: 13/544,133

(22) Filed: Jul. 9, 2012

Related U.S. Application Data
(63) Continuation-in-part of application No. 12/652,788, filed on Jan. 6, 2010.

(51) Int. Cl. F01D 25/00; F02C 7/22; F02C 7/00; F01D 5/28; F04D 29/66

(52) U.S. Cl. CPC F01D 25/005; F01D 5/28; F04D 29/66; F02C 7/00; F02C 7/22
USPC 428/448; 416/241 B; 415/119; 60/753; 60/740; 428/446

(57) ABSTRACT

A coating material suitable for use in high temperature environments and capable of providing a damping effect to a component subjected to vibration-induced stresses. The coating material defines a damping coating layer of a coating system that lies on and contacts a substrate of a component and defines an outermost surface of the component. The coating system includes at least a second coating layer contacted by the damping coating layer. The damping coating layer contains a ferroelastic ceramic composition having a tetragonality ratio, c/a, of greater than 1 to 1.02, where “c” is a c axis of a unit cell of the ferroelastic ceramic composition and “a” is either of two orthogonal axes, a and b, of the ferroelastic ceramic composition.

### CROSS REFERENCE TO RELATED APPLICATIONS

This is a continuation-in-part patent application of co-pending U.S. patent application Ser. No. 12/652,788, filed Jan. 6, 2010. The contents of this prior application are incorporated herein by reference.

### BACKGROUND OF THE INVENTION

The present invention generally relates to coatings and coating materials. More particularly, this invention relates to coatings, coating materials and coating systems capable of providing a damping effect for components subjected to vibration-induced stresses, nonlimiting examples of which include turbine components.

Higher operating temperatures for turbines are continuously sought in order to increase their efficiency. As a particular example, nickel-, cobalt- and iron-base superalloys have found wide use as materials for components of gas turbine engines in various industries, including the aircraft and power generation industries. Thermal barrier coatings (TBC) are commonly used to increase the high temperature durability of turbine engine components, particular examples of which include combustors, airfoil components such as high pressure turbine (HPT) blades (buckets) and vanes (nozzles), and other hot section components of gas turbine engines. TBCs typically comprise a thermal-insulating ceramic material, a notable example being yttria-stabilized zirconia (YSZ) that is widely used because of its high temperature capability, low thermal conductivity, and relative ease of deposition. TBCs are typically deposited on an environmentally-protective bond coat to form what may be termed a TBC system. Bond coat materials widely used in TBC systems include oxidation-resistant overlay coatings such as MCrAlX (where M is iron, cobalt and/or nickel, and X is yttrium, a rare-earth metal, and/or another reactive metal), and oxidation-resistant diffusion coatings.

Alternative materials have been proposed for a variety of high temperature applications, including ceramic matrix composite (CMC) materials for use as combustor liners, shrouds, airfoil components, and other hot section components of gas turbine engines. A particular example is silicon-based non-oxide ceramics, most notably with silicon carbide (SiC), silicon nitride (Si₃N₄), and/or silicides serving as a reinforcement phase and/or a matrix phase. When exposed to a high-temperature, water vapor-rich combustion atmosphere such as that within a gas turbine engine, components formed of Si-based ceramics lose mass and recede because of the formation of volatile silicon hydroxide (Si(OH)₄). Consequently, CMC components proposed for use in gas turbine engine environments are typically protected with what is commonly referred to as an environmental barrier coating (EBC). Rare-earth oxides and silicates, particularly barium-strontium-aluminosilicates (BSAS; (Ba₁₋ₓSrₓ)O—Al₂O₃—SiO₂) and other alkaline-earth aluminosilicates, have been proposed as EBCs for Si-based CMC components in view of their environmental protection properties and low thermal conductivity. If a particular CMC component is to be subjected to sufficiently high surface temperatures, its EBC can be thermally protected with a TBC, as taught in U.S. Pat. No. 5,985,470 to Spitsberg et al. YSZ is commonly proposed as a TBC material for protecting EBC's on CMC components. A transition layer may be provided between the TBC and underlying EBC, for example, mixtures of YSZ with alumina, mullite, and/or an alkaline-earth metal aluminosilicate, as taught in commonly-assigned U.S. Pat. No. 6,444,335 to Wang et al.

In addition to the harsh thermal and chemical environment present during the operation of a turbine engine, components of these engines are subjected to vibrational stresses that can shorten their fatigue lives. One solution is to provide vibration damping capable of altering the vibrational characteristics of a component. Examples include mechanical systems such as spring-like dampers located at the attachment of an airfoil component to a rotor, and dampers located at a tip shroud of an airfoil component. While effective for components formed of metallic materials, CMC components are more difficult to mechanically damp than their metal counterparts because CMC materials are harder and tend to aggressively wear into components of a mechanical damping system. In addition, a high coefficient of friction between a CMC component and a mechanical damping system can reduce the damping effect. In addition, mechanical damping system apply loads that, in the case of a CMC component, may lead to premature failure of the component if the load is applied in a direction transverse to its principal (load-bearing) direction.

In view of the above, there is an ongoing need for systems capable of providing a damping effect to components subjected to vibration-induced stresses, including but not limited to CMC components within hot gas paths of turbines.

### BRIEF DESCRIPTION OF THE INVENTION

The present invention generally provides coatings, coating materials and coating systems that is suitable for use in high temperature environments, including but not limited to turbines and in particular the hot gas paths of gas turbine engines used in the aircraft and power generation industries. The coatings are capable of providing a damping effect to a component subjected to vibration-induced stresses by altering the vibrational characteristics of the component. The coating is particularly suitable for use with CMC components, including Si-containing materials such as silicon, silicon carbide, silicon nitride, metal silicide alloys such as niobium and molybdenum silicides, etc., though its use on components formed of metallic compositions, such as nickel-, cobalt- and iron-based superalloys, is also within the scope of the invention.

According to a first aspect of the invention, a component is provided that has a substrate and a coating system on the substrate. The coating system is on and contacts the substrate and defines an outermost surface of the component. The coating system includes a damping coating layer and at least a second coating layer contacted by the damping coating layer. The damping coating layer contains a ferroelastic ceramic composition having a tetragonality ratio, c/a, of greater than 1 to 1.02, where “c” is a c axis of a unit cell of the ferroelastic ceramic composition and “a” is either of two orthogonal axes, a and b, of the ferroelastic ceramic composition.

According to a second aspect of the invention, a gas turbine engine component is provided having a substrate formed of a silicon-containing ceramic matrix composite material comprising a matrix material that contains a reinforcement material. At least one of the matrix and reinforcement materials is silicon carbide, silicon nitride, a silicide and/or silicon. A coating system lies on and contacts the substrate and defines an outermost surface of the component. The coating system includes a damping coating layer and at least a second coating layer contacted by the damping coating layer. The damping coating layer contains tetragonal zirconia consisting of about 8 to about 15 weight percent yttria, at least 19 to at most 28 weight percent tantala, with the balance zirconia and incidental impurities. The tetragonal zirconia has a tetragonality ratio, c/a, of greater than 1 to 1.02, where “c” is a c axis of a unit cell of the tetragonal zirconia and “a” is either of two orthogonal axes, a and b, of the tetragonal zirconia.

A technical effect of the invention is that the ferroelastic ceramic composition enables the damping coating layer to damp vibrational stresses applied to a component on which the damping coating layer has been formed, which in turn is capable of increasing the structural integrity and durability of the component and extending its useful life. As such, the damping coating layer is also capable of reducing the operational cost of a turbine by extending its service life and reducing the replacement and/or repair costs of its components. The coating layer is also compatible for use with known coating materials used in thermal barrier and environmental barrier coating (TBC and EBC) systems used in turbine applications, and can be deposited using various processes known and commonly used in the art.

Other aspects and advantages of this invention will be better appreciated from the following detailed description.

### BRIEF DESCRIPTION OF THE DRAWINGS

FIG. 1 shows a schematic cross-section illustration of a portion of an industrial gas turbine engine.

FIG. 2 shows a more detailed cross-sectional view of the turbine section of the gas turbine engine of FIG. 1.

FIG. 3 schematically represents a turbine bucket having an airfoil surface provided with a damping coating system in accordance with an embodiment of the present invention.

FIG. 4 schematically represents a cross-sectional view of a surface region of the bucket of FIG. 3 showing the damping coating system as comprising multiple layers.

FIG. 5 diagrammatically represents a ferroelastic switching capability of a damping coating layer of the coating system of FIG. 4.

### DETAILED DESCRIPTION OF THE INVENTION

The present invention provides a damping coating system suitable for use in high temperature environments, including but not limited to turbines and especially the hot gas paths of gas turbine engines used in the aircraft and power generation industries. The coating system contains at least one coating layer that is adapted to provide a damping effect to a component subjected to vibration-induced stresses by altering the vibrational characteristics of the component. Notable but nonlimiting examples of such components include combustor components, turbine blades (buckets) and vanes (nozzles), and other components subjected to vibration-induced stresses within gas turbine engines used in various industries, including the aircraft and power generation industries. As such, the invention can find use with components such as struts, turbine casings, rotors, fuel nozzles, combustion casings, combustion liners, and transition pieces.

The damping coating system is suitable for use on components formed of superalloy and/or CMC materials, and can be used in combination with coating materials used in protective TBC and EBC systems applied to superalloy and CMC components. Nonlimiting examples of superalloy materials include nickel-based, cobalt-based and iron-based alloys, and nonlimiting examples of CMC materials include materials whose reinforcement and/or matrix material is or contains silicon, silicon carbide (SiC), silicon carbide incorporating Ti, Zr or Al, silicon oxy-carbide (SiOₓC_{y}), silicon boro-carbo-nitride (SiBₓC_{y}N_{z}), silicon dioxide (SiO₂), silicon nitride, metal silicides (such as niobium and molybdenum silicides), carbon, aluminum oxide (Al₂O₃), mullite, zirconium dioxide (ZrO₂), and combinations thereof. Advantages of the invention will be described below with reference to gas turbine engine components formed of Si-containing CMC materials. However, the teachings of the invention are not so limited and instead may find use in a wide variety of additional applications that may or may not contain rotating hardware, including rocket engines and supersonic combustion ram (SCRAM) jet engines.

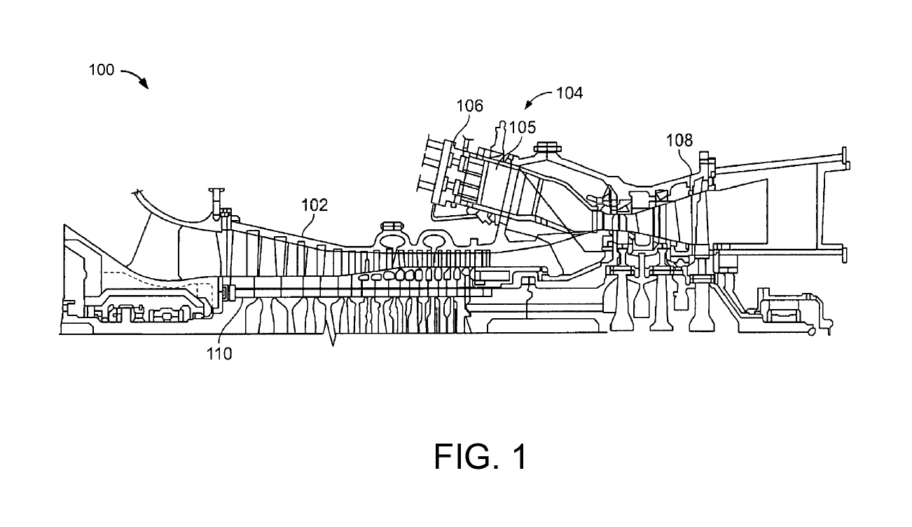

FIG. 1 is a schematic illustration of an embodiment of a gas turbine engine 100 that includes a compressor section 102 and a combustor section 104. The combustor section 104 includes a combustion region 105 and a fuel nozzle assembly 106. The engine 100 also includes a turbine section 108 coupled to the compressor section 102 by a common shaft 110. The engine 100 is representative of an industrial gas turbine engine, a non-limiting example of which is the MS7001FB engine, sometimes referred to as a 7FB engine, commercially available from General Electric Company. However, the present invention is not limited to any particular engine or type of engine.

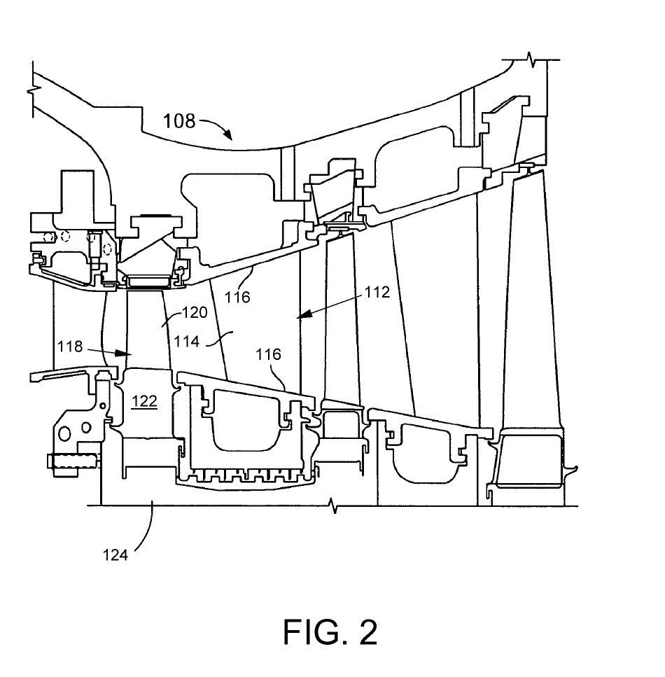

During the operation of the engine 100, air flows through the compressor section 102 where it is compressed before being supplied to the combustor section 104. The fuel nozzle assembly 106 channels a mixture of fuel and the compressed air to the combustion region 105 of the combustor section 104, where the fuel-air mixture is ignited before being delivered to the turbine section 108. Gas turbine engines of the type illustrated will typically comprise a plurality of fuel nozzle assemblies 106 and combustion regions 105 of the type represented in FIGS. 1 and 2, which are located about the periphery of the engine 100

FIG. 2 provides a more detailed cross-sectional illustration of the turbine section 108, and represents the turbine section 108 as containing multiple states of nozzles (vanes) 112 and buckets (blades) 118 immediately downstream of the combustor section 104 (not shown in FIG. 2) of the engine 100. Each stage comprises a nozzle assembly 112 made up of an annular array of circumferentially-spaced vanes 114 and an annular array of circumferentially-spaced buckets 118 (one vane 114 and one bucket 118 are represented for each stage in FIG. 2). The vanes 114 of the nozzle assemblies 112 are statically mounted between platforms (bands) 116 within the turbine section 108, whereas the buckets 118 are mounted on a rotating component 124, commonly referred to as a wheel, of the engine 100 to enable rotation of the buckets 118 relative to the nozzle assemblies 112. As represented in FIG. 2, each bucket 118 comprises an airfoil 120 extending from a shank 122 in a radially outward direction from the wheel 124.

The airfoils 114 and 120 of the nozzle assemblies 112 and buckets 118 are directly subjected to the hot gas path within the turbine section 108. Furthermore, the nozzle assemblies 112 and buckets 118 are subjected to vibrations resulting from the operation of the engine 100. Because vibration induces stresses that can shorten the fatigue lives of the nozzle assemblies 112 and buckets 118, the present invention provides the aforementioned damping coating system, which contains at least one coating layer adapted to provide a damping effect to a component subjected to vibration-induced stresses, particular but nonlimiting examples of which include the nozzle assemblies 112 and buckets 118 of FIG. 2.

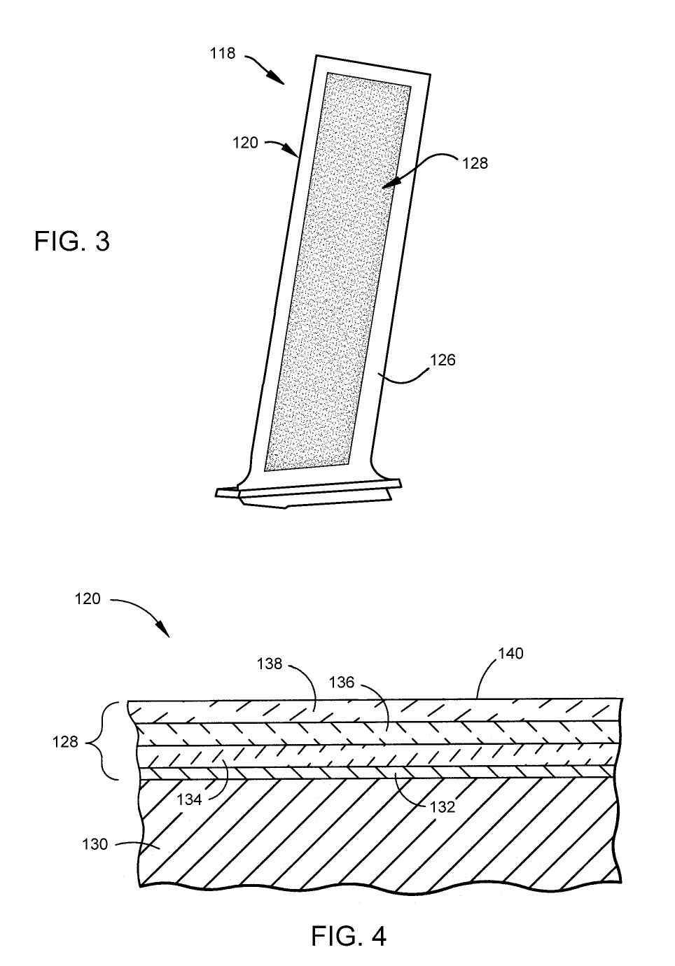

As an example, FIG. 3 schematically represents one of the buckets 118 of FIG. 2 as having a surface 126 of its airfoil 120 provided with a damping coating system 128. While the coating system 128 is represented in FIG. 3 as covering a limited region of the airfoil surface 126, it is within the scope of the invention that the coating system 128 could be provided on other or additional surface regions of the bucket 118, and may cover the bucket 118 or its airfoil 120 in their entirety.

The coating system 128 is represented in FIG. 4 as being or forming part of a multilayer environmental barrier coating (EBC) system that protects a silicon-based substrate region 130 of the bucket airfoil 120. As such, the coating system 128 of FIG. 4 represents one of a variety of different coating systems that can incorporate a vibration-damping capability desired for the present invention. As a particular example, the coating system 128 can be described as including a bondcoat 132, shown in FIG. 4 as being directly applied to the surface of the substrate 128 (which would, in reference to FIG. 3, correspond to the surface 126 of the airfoil 120). If the substrate 130 is one of the aforementioned Si-based CMC materials, a preferred composition for the bondcoat 132 consists of elemental silicon or a silicon-containing composition. The bondcoat 132 is further represented as bonding an environmental barrier layer 134 to the substrate 130, and optionally multiple additional layers of the coating system 128. Suitable materials for the environmental barrier layer 134 include, but are not limited to, silicates, alkaline-earth metal aluminosilicates and/or rare-earth metal silicates, and particularly compounds of rare-earth oxides and silicates such as barium-strontium-aluminosilicates (BSAS) and other alkaline-earth aluminosilicates. The optional layers may include, for example, a thermal barrier coating (TBC) 138 that, if present, defines the outermost surface 140 of the coating system 128 and the bucket 118. Suitable materials for the TBC 138 include, but are not limited to, YSZ alone or with additions of rare-earth oxides capable of promoting properties of the TBC 18, though a TBC 138 formed of other ceramic materials is also foreseeable, for example, zirconate or perovskite materials. The coating system 128 may further include one or more additional environmental barrier layers and/or one or more transition layers (not shown) between the bondcoat 132 and the TBC 138, the latter of which can be used to mitigate any mismatch between layers of the coating system 128, for example, differences in composition and/or coefficients of thermal expansion.

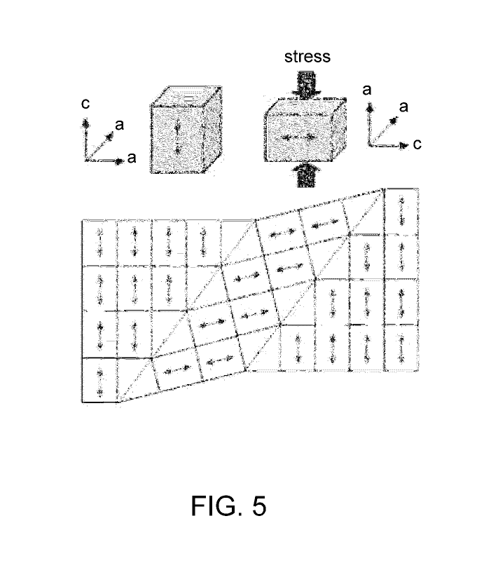

The coating system 128 is intended to provide environmental protection to the underlying substrate 130, as well as to provide the desired vibration damping effect to promote the fatigue life of the bucket 118 within the high temperature operating environment of a gas turbine engine. For this purpose, the coating system 128 further includes a damping coating layer 136 which, in the embodiment of FIG. 4 is represented as being between the environmental barrier layer 134 and the TBC 138. According to preferred embodiments of the present invention, the damping coating layer 136 is a ceramic composition that exhibits ferroelasticity, which may be characterized by the existence of a hysteresis loop between the strain exhibited by the composition when subjected to an applied stress. Ferroelasticity may be further described as a phenomenon in which a material exhibits a spontaneous strain in response to the application of stress, resulting in a domain change in the material from one orientation to an equally stable but different orientation (a “twin” phase). A particular example of a ferroelastic material is zirconia (ZrO₂) stabilized in the tetragonal crystal phase to inhibit a tetragonal to monoclinic crystal phase transformation at elevated temperatures. According to a preferred aspect of the invention, a zirconia-based ceramic composition of the coating layer 136 contains one or more stabilizers to inhibit the tetragonal to monoclinic crystal phase transformation, and in addition contains an amount of at least one dopant that causes the tetragonality ratio, c/a, of the composition to be greater than 1 to 1.02, where “c” corresponds to the c axis of a unit cell of the composition and “a” corresponds to either of the other two orthogonal axes, a and b (=a), of the composition. More preferably, the c axis is 1% to 2% larger than the other two orthogonal axes, a and b (=a), corresponding to a tetragonality ratio of 1.01 to 1.02. As schematically represented in FIG. 5, an applied compressive stress (of the order of the coercive stress, σ_{c}), for example, induced by vibration stresses along the c axis can promote a ferroelastic transformation of the c axis to one of the other two orthogonal axes with an accompanying ferroelastic strain that is proportional to the tetragonality ratio, c/a. As is also schematically represented in FIG. 5, the ferroelastic transformation does not occur as a simultaneous switching of all unit cells, but rather proceeds by the transformation of domains with similar orientations.

On the basis of the above, the coating layer 136 of the present invention requires the c-axis of the unit cell to be 1 to 2% of the other two axes. While prior art TBCs formed of tantala-doped YSZ compositions have been proposed, including TBCs containing 6-8% yttria and 4-15% tantala (see U.S. Published Patent Application No. 2009/0110953), such compositions have been proposed for improving TBC performance relative to failure modes such as spallation, erosion, reduced effectiveness and delamination. In contrast, the present invention is narrowly tailored to contain tantala and one or more stabilizers to achieve a metallurgical damping that, unlike mechanical damping, relies on a molecular interaction that is neither intuitive nor predictable.

According to preferred embodiments of the invention, the composition of the coating layer 136 is zirconia stabilized by yttria (Y₂O₃) and optionally one or more additional stabilizers to inhibit the tetragonal to monoclinic crystal phase transformation, and the dopant is tantala (Ta₂O₅) in an amount of at least 19 to at most 28 weight percent so that the c axis of a unit cell of the stabilized zirconia is approximately 1% to approximately 2% greater than the other two orthogonal axes, a and b (=a). More particularly, the c axis of a unit cell of the stabilized zirconia is at least 1% to at most 2% greater than the other two orthogonal axes, a and b (=a). In practice, a particularly suitable composition for the damping coating layer 136 has been shown to be a ferroelastic ceramic composition of zirconia stabilized by about 8 to about 15 weight percent yttria and containing at least 19 to at most 28 weight percent tantala, with the balance essentially or entirely zirconia. As a specific example, a coating layer 136 consisting of, by weight, 8.02% yttria, 19.22% tantala, and the balance zirconia has been shown to exhibit particularly desirable damping characteristics. The coating layer 136 may contain additional stabilizers and additives, generally as substitutions for the yttria content of the coating layer 136. Such stabilizers and additives include various oxides and rare-earth oxides, particular but nonlimiting examples of which include one or more of calcia (CaO), magnesia (MgO), titania (TiO₂), ceria (CeO₂) and ytterbia (Yb₂O₃). For stabilizing zirconia in the non-transformable tetragonal phase, suitable limits for these stabilizers and additives can be determined from their specific phase diagrams with zirconia.

The damping coating layer 136 is preferably capable of exhibiting sufficient ferroelastic properties to provide vibrational damping at high temperatures, for example, at temperatures above 700° C. and preferably extending to at least 1350° C. Other ferroelastic materials exhibiting the desired c/a ratio at temperatures above 700° C. are foreseeable, and may include, for example, the ferroelastic ceramic composition, by weight, 7.49% yttria, 4.4% titania, 2.67% tantala, and the balance zirconia.

Various methods can be potentially employed to form the damping coating layer 136 as well as the remaining layers of the coating system 128, including such well known deposition techniques as thermal spray processes, for example, air and vacuum plasma spraying (APS and VPS, respectively), chemical vapor deposition (CVD) and high velocity oxy-fuel (HVOF) processes, as well as such known techniques as slurry coating and PVD techniques. Such coating methods are known and therefore will not be described in any detail here.

Though FIG. 4 represents the damping coating layer 136 as being a discrete layer within the coating system 128, it is foreseeable that the damping characteristics desired with this layer 136 can be achieved with one or more layers that contain a mixture that contains a ceramic composition having the aforementioned ferroelastic properties and high temperatures capability. Such a damping coating layer 136 may contain a uniform mixture of the ferroelastic ceramic composition and one or more other ceramic compositions, for example, the ceramic composition of the environmental barrier layer 134 or TBC 138. Alternatively, the damping coating layer 136 may be a compositionally graded layer, wherein the concentrations of the ferroelastic ceramic composition and the one or more other ceramic compositions continuously change through the thickness of the layer 136. As a nonlimiting example, the damping coating layer 136 may contain a mixture of the aforementioned tantala-doped YSZ ferroelastic ceramic composition and the composition of the environmental barrier layer 134, in which case the damping coating layer 136 can be directly deposited on the environmental barrier layer 134, or vice versa.

Investigations leading to the present invention included the testing of a rare-earth oxide doped tetragonal zirconia coating. The coating consisted of about, by weight, 8.02% yttria, 19.22% tantala, and the balance zirconia and incidental impurities. The coating was applied by thermal spraying tests plates formed of a nickel-base alloy (GTD444®) and was deposited to a thickness of approximately 0.025 inch (0.635 millimeters). The test plates were mounted to a shaker within a box furnace and subjected to vibration at about 1400° F. (about 760° C.). Damping tests were performed on these plates after they were thermally exposed at 0, 800 and 2000 hours, respectively. The coating showed an approximately four to five time reduction in the amplification factor (Q) with minimal change in Q and room temperature (RT) natural frequency. These tests were concluded to establish that the rare-earth oxide doped tetragonal zirconia coating produced a desirable damping characteristic.

While the invention has been described in terms of a particular embodiment, it is apparent that other forms could be adopted by one skilled in the art. Accordingly, the scope of the invention is to be limited only by the following claims.

1. A component comprising a substrate and a coating system on the substrate, the coating system being on and contacting the substrate, defining an outermost surface of the component, and comprising:
a damping coating layer containing a ferroelastic ceramic composition having a tetragonality ratio, c/a, of greater than 1 to 1.02, where “c” is a c axis of a unit cell of the ferroelastic ceramic composition and “a” is either of two orthogonal axes, a and b, of the ferroelastic ceramic composition; and
at least a second coating layer contacted by the damping coating layer.

2. The component according to claim 1, wherein the substrate is formed of a silicon-containing ceramic matrix composite material comprising a matrix material that contains a reinforcement material, and at least one of the matrix and reinforcement materials is chosen from the group consisting of silicon carbide, silicon nitride, silicides and silicon.

3. The component according to claim 2, wherein the second coating layer is an environmental barrier layer.

4. The component according to claim 3, wherein the environmental barrier layer comprises silicates, alkaline-earth metal aluminosilicates, and/or rare-earth metal silicates.

5. The component according to claim 3, wherein the environmental barrier layer consists of silicates, alkaline-earth metal aluminosilicates, and/or rare-earth metal silicates.

6. The component according to claim 3, wherein the coating system further comprises at least one bondcoat between the substrate and the second coating layer, the bondcoat being elemental silicon or a silicon-containing composition.

7. The component according to claim 1, wherein the coating system further comprises a thermal barrier coating that defines the outermost surface of the component.

8. The component according to claim 7, wherein the thermal barrier coating comprises yttria-stabilized zirconia.

9. The component according to claim 1, wherein the ferroelastic ceramic composition of the damping coating layer is tetragonal zirconia consisting of about 8 to about 15 weight percent yttria, at least 19 to at most 28 weight percent tantala, with the balance zirconia and incidental impurities.

10. The component according to claim 9, wherein the damping coating layer consists of the ferroelastic ceramic composition.

11. The component according to claim 9, wherein the damping coating layer contains a mixture of the ferroelastic ceramic composition and a second ceramic composition contained by the second coating layer.

12. The component according to claim 11, wherein the damping coating layer defines the outermost surface of the component.

13. The component according to claim 1, wherein the component is a component of a gas turbine engine.

14. The component according to claim 13, wherein the component is chosen from the group consisting of turbine airfoil components, struts, turbine casings, rotors, fuel nozzles, combustion casings, combustion liners, and transition pieces.

15. The component according to claim 13, wherein the gas turbine engine is chosen from the group consisting of aircraft and power generation gas turbine engines.

16. A gas turbine engine component comprising:
a substrate formed of a silicon-containing ceramic matrix composite material comprising a matrix material that contains a reinforcement material, at least one of the matrix and reinforcement materials being chosen from the group consisting of silicon carbide, silicon nitride, silicides and silicon; and
a coating system on and contacting the substrate and defining an outermost surface of the component, the coating system comprising a damping coating layer and at least a second coating layer contacted by the damping coating layer, the damping coating layer containing tetragonal zirconia consisting of about 8 to about 15 weight percent yttria, at least 19 to at most 28 weight percent tantala, with the balance zirconia and incidental impurities, the tetragonal zirconia having a tetragonality ratio, c/a, of greater than 1 to 1.02, where “c” is a c axis of a unit cell of the tetragonal zirconia and “a” is either of two orthogonal axes, a and b, of the tetragonal zirconia.

17. The gas turbine engine component according to claim 16, wherein the second coating layer is an environmental barrier layer.

18. The gas turbine engine component according to claim 17, wherein the environmental barrier layer comprises silicates, alkaline-earth metal aluminosilicates, and/or rare-earth metal silicates.

19. The gas turbine engine component according to claim 16, wherein the damping coating layer consists of the tetragonal zirconia.

20. The gas turbine engine component according to claim 16, wherein the damping coating layer contains a mixture of the tetragonal zirconia and a second ceramic composition contained by the second coating layer.
